(19) United States
(12) Patent Application Publication
(10) Pub. No.: US 2012/0054359 A1
(43) Pub. Date: Mar. 1, 2012

(54) Network Relay Device and Frame Relaying Control Method

(75) Inventor: Daisuke Yamada, Nagoya-shi (JP)

(73) Assignee: BUFFALO INC., Nagoya-shi (JP)

(21) Appl. No.: 13/215,252

(22) Filed: Aug. 23, 2011

(30) Foreign Application Priority Data
Aug. 24, 2010 (JP) 2010-186831

(51) Int. Cl. G06F 15/16

(52) U.S. Cl. 709/229

(57) ABSTRACT

A network relay device includes: a plurality of ports to which external devices connect, and configured pre-correlated with types of authentication to be conducted with respect to connected external devices; an authentication process section for determining, when an external device is connected to the network relay device, the type of authentication that the port to which the external device is connected is configured for, and if the determined type of authentication is a first authentication type, conducting mutual authentication between the network relay device and the external device using an authentication protocol chosen from among a plurality of authentication protocol candidates in accordance with type of connected external device; and a relay process section for relaying frames received from an external device with which authentication by the authentication process section has succeeded.

### CROSS REFERENCE TO RELATED APPLICATION

The disclosure of Japanese Patent Application No. 2010-186831, filed on Aug. 24, 2010, is incorporated herein by reference.

### BACKGROUND OF THE INVENTION

1. Field of the Invention

The present invention relates to network relay devices and methods that the network relay devices execute for controlling relay of data frames received from external devices.

2. Description of the Background Art

Accompanying advances in information and communications technology (ICT), switching products known as intelligent switches have appeared. Such intelligent switches signify switching that is highly functional by comparison to general switches. Intelligent switches have a variety of functions including, for example, virtual local area network (VLAN) functions, security functions, and functions related to quality of service (QoS) (cf., for example, Japanese Laid-Open Patent Publication No. 2008-48252). Among the functions described above, improvement in security functions in particular that place a premium on threats within networks has been in demand in recent years.

Widely used in general as a security function that stresses the importance of threats within a network is a function called port-level security that restricts input of traffic, based on MAC addresses stored in external devices connected to intelligent-switch ports.

Meanwhile, there is a trade-off relationship between convenience and strengthening security, and the fact of the matter is pursuing one leads to sacrificing the other. For example, when port-level security functions are adopted in intelligent switches, normally a network administrator configures the individual ports of an intelligent switch as to whether security is enabled or disabled, the MAC addresses of external devices that will be permitted to input traffic, the designation of how breaches in security are to be handled, etc.

Within the corporate workplace in recent years, however, employees using personal mobile terminals, smart phones, and the like for work, as well as guest users, such as fixed-term contract personnel and staff from affiliated and client companies, have been on the increase. Thus, changes in the network configuration occur frequently. Consequently, network administrators have to deal with changes in the network configuration while ensuring security, such that a problem for network administrators has been an increased burden in managing network configurations.

What is more, this sort of problem has not been limited to intelligent switches, but on the whole has been a problem common to network relay devices with security functions.

Therefore, an object of the present invention is to make available network relay devices and data-frame relaying control methods capable of flexibly dealing with changes in network configuration while ensuring security.

### SUMMARY OF THE INVENTION

The present invention is directed toward a network relay device that relays data frames received from external devices. In addition, in order to achieve the above described object, the network relay device of the present invention includes: a plurality of ports to which external devices connect, and configured pre-correlated with types of authentication to be conducted with respect to connected external devices, the types of authentication including a first authentication type and a second authentication type; an authentication process section for determining, when an external device is connected to the network relay device, the type of authentication that the port to which the external device is connected is configured for, and if the determined type of authentication is the first authentication type, conducting mutual authentication between the network relay device and the external device using an authentication protocol chosen from among a plurality of authentication protocol candidates in accordance with type of connected external device; and a relay process section for relaying frames received from an external device with which authentication by the authentication process section has succeeded. The type of the external device can be determined based on identifiers included in frames received from the connected external device.

In the network relay device, if the authentication process section determines the authentication type to be the second authentication type, the authentication process section conducts mutual authentication between the network relay device and the external device using a predetermined authentication protocol, regardless of the type of connected external device.

In addition, in the network relay device, after an external device has been connected to the network relay device, the replay process section, in response to generation of a predetermined trigger, may stop relaying frames received from the external device, and, if the authentication process section has received a key-exchange frame indicating that an exchange of keys used for authentication is being requested, the authentication process section may conduct a process for exchanging keys with that external device which is connected to the port through which the key-exchange frame has been received.

The plurality of authentication protocol candidates preferably includes at least one authentication protocol among EAP-MD5, EAP-TLS, EAP-TTLS, PEAP, LEAP, and EAP-FAST. Furthermore, the predetermined authentication protocol is preferably any one authentication protocol among EAP-MD5, EAP-TLS, EAP-TTLS, PEAP, LEAP, and EAP-FAST.

Furthermore, when a permission list for identifying, by the use of information included in frames received from an external device, frames that are relay-eligible is stored in the network relay device, the relay process section may include an authentication information management section for changing content stipulated in the permission list in response to an external device's state of connection. If the external device is connected to the port configured for the first authentication type, the authentication information management section preferably changes the content stipulated in the permission list so as to enable relay of frames received from the connected external device. If the external device is connected to the port configured for the second authentication type and if the authentication by the authentication process section has succeeded, the authentication information management section preferably changes the content stipulated in the permission list so as to enable relay of frames received from the connected external device. Furthermore, when the authentication information management section has changed the content of the permission list, the authentication information management section preferably further transmits the content of the changed permission list to a separate network relay device connected to the network relay device.

The authentication process section preferably configured to function both as an authentication client based on IEEE 802.1X and as an authentication server based on IEEE 802.1X. In addition, when a separate network relay device is connected to the network relay device and if the MAC address of the separate network relay device is pre-registered in the network relay device as a MAC address for which connection is to be permitted, the authentication process section may treat the separate network relay device as a partner with which mutual authentication has succeeded.

The above described configuration of the present invention allows to flexibly deal with changes in network configuration while ensuring security in a network relay device. As a result, both convenience and improvement in security can be achieved.

It should be noted that the present invention can be attained in various modes. For example, the present invention can be attained in modes including network relay devices, methods for controlling network relay devices, network systems using network relay devices, and computer programs that achieve the functions of these methods or devices, and storage media having stored therein such computer programs.

The present invention is applicable to network systems and the like including a relay device and a wireless communication device; and is particularly useful when there is a need to improve security for wireless communications. These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a schematic configuration of terminals and a network relay device according to a first embodiment of the present invention;

FIG. 2 is a diagram schematically representing the configuration of the network relay device according to the first embodiment;

FIG. 3 is a chart presenting one example of an authentication protocol list;

FIG. 4 is a chart presenting one example of a permission list;

FIG. 5 is a chart presenting one example of an authentication protocol candidate list;

FIG. 6 is a flowchart showing a procedural sequence of processes conducted by the network relay device when a frame is received;

FIG. 7 shows a situation prior to having mutual authentication conducted when a separate network relay device is connected to the network relay device;

FIG. 8 is a sequence diagram showing flow of an EAP_SW mode authentication process (step S36 in FIG. 6);

FIG. 9 shows a situation after having mutual authentication conducted when the separate network relay device is connected to the network relay device;

FIG. 10 shows a situation prior to having mutual authentication conducted when a terminal is connected to the network relay device;

FIG. 11 is a sequence diagram showing flow of an EAP_PC mode authentication process (step S38 in FIG. 6);

FIG. 12 shows a situation after having mutual authentication conducted when the terminal is connected to the network relay device;

FIG. 13 is an explanatory diagram schematically representing a configuration of a network relay device according to a second embodiment of the present invention; and

FIG. 14 is a sequence diagram showing flow of a key exchange process.

### DESCRIPTION OF THE PREFERRED EMBODIMENTS

Embodiments of the present invention will be described in the following with reference to the drawings.

### First Embodiment

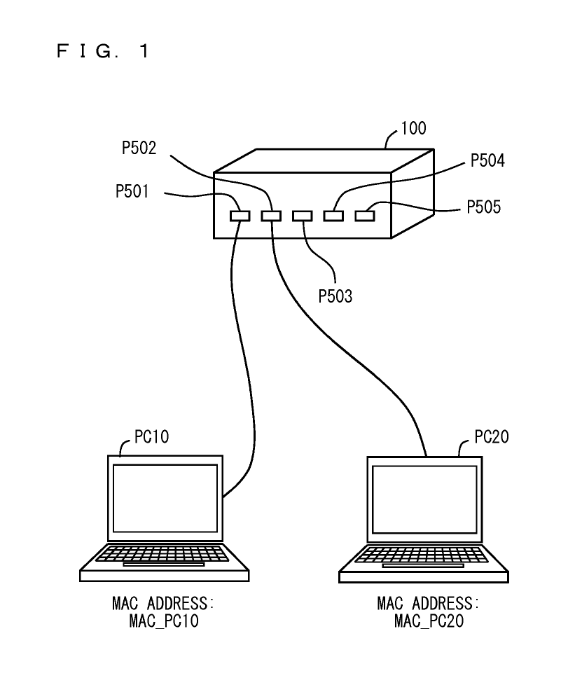

FIG. 1 is a diagram showing a schematic configuration of a terminal PC10, a terminal PC20, and a network relay device 100 according to a first embodiment of the present invention. The network relay device 100 according to the first embodiment is a so-called layer 2 switch, and functions to relay a frame by using a MAC (Media Access Control) address. Layer 2 corresponds to the second layer (data link layer) of the OSI (Open Systems Interconnection) reference model. In the following, descriptions are provided by representing the network relay device 100 as a switch 100. An external device (e.g., a terminal or another switch) is connected to the switch 100 via five ports, P501 to P505.

In the example shown in FIG. 1, the terminal PC10, which is a personal computer or the like, is connected to the port P501 via a line. The MAC address of the terminal PC10 is MAC_PC10. The terminal PC20, which is a personal computer or the like, is connected to the port P502 via a line. The MAC address of the terminal PC20 is MAC_PC20. It should be noted that, those that are unnecessary for the descriptions, such as other network devices, lines, terminals, and the internal configuration of the switch 100, are not diagrammatically represented in FIG. 1 for convenience. The same applies for all the figures describe later.

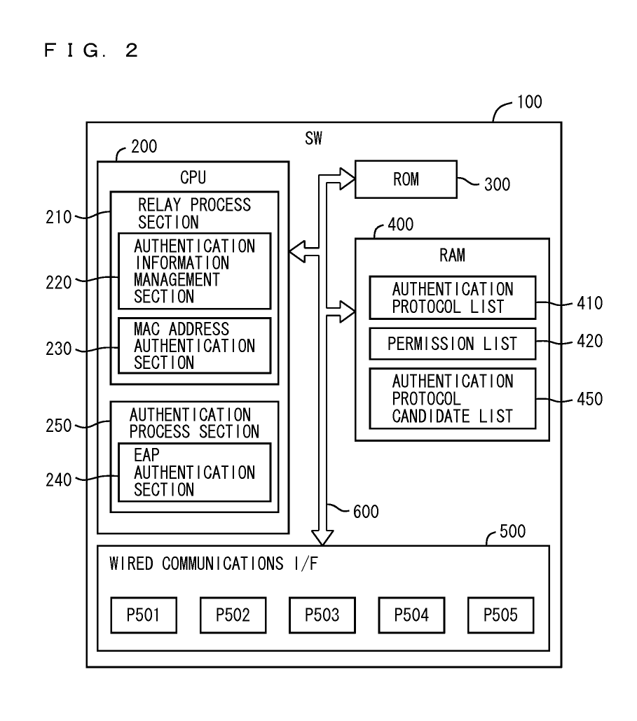

FIG. 2 is a diagram schematically representing the configuration of the switch 100 according to the first embodiment. The switch 100 includes a CPU 200 (Central Processing Unit), a ROM (Read Only Memory) 300, a RAM (Random Access Memory) 400, and a wired communications interface (wired communications I/F) 500. All the components of the switch 100 are connected to each other via a bus 600.

The CPU 200 controls each section of the switch 100 by loading a computer program stored in the ROM 300 onto the RAM 400 and executing the computer program. In addition, the CPU 200 also functions as a relay process section 210 and an authentication process section 250. The relay process section 210 includes an authentication information management section 220 and a MAC address authentication section 230, and functions to relay a frame received (described as a received frame in the following) via a wired communications interface 500. The main functions of the authentication information management section 220 include a function of updating a permission list 420 stored in the RAM 400 which is a storing section, and a function of exchanging the permission list 420 with another switch. The MAC address authentication section 230 functions as a determination process section for conducting a process of determining whether the received frame is eligible to be relayed. An EAP (Extensible Authentication Protocol) authentication section 240, which is included in the authentication process section 250, functions to conduct mutual authentication between the switch 100 and an external device when the external device (e.g., a terminal or another switch) is connected to the switch 100. Details of each of these functional sections will be described later.

An authentication protocol list 410, the permission list 420, and an authentication protocol candidate list 450 are stored in the RAM 400. Details of each of these lists will be described later. The wired communications interface 500 is a connection opening for a LAN cable, and is used to connect to a local area network (LAN). The wired communications interface 500 includes the five ports, P501 to P505. In the present embodiment, the ports P501 to P504 are ports used for connecting to external devices (e.g., personal computers, mobile terminals, and the like) other than switches. The port P505 is a port used for connecting to other switches in cascade.

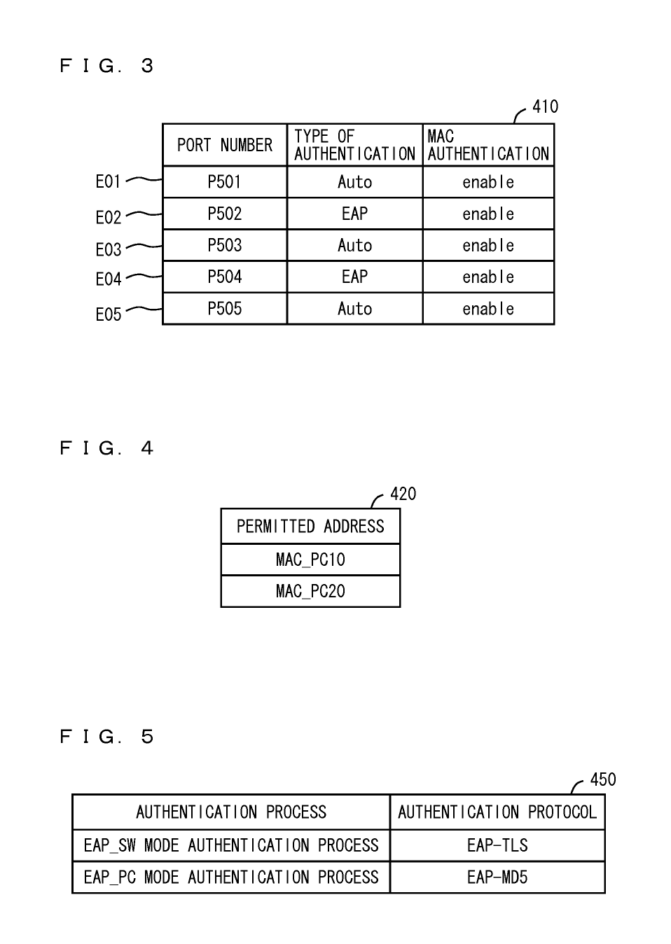

FIG. 3 is a chart presenting one example of the authentication protocol list 410. The authentication protocol list 410 includes a port number field, an authentication-type field, and a MAC authentication field. Identifiers of all the ports included in the switch 100 are stored as entries of the port number field. The identifiers in the present embodiment are “P501” to “P505.”

Stored in the authentication-type field is data representing the type of authentication predetermined for each of the ports stored in the port number field. The type of authentication refers to the type of authentication that is to be conducted by the EAP authentication section 240 for an external device (a terminal, or another switch) when the external device is connected to a port. The types of authentication used in the present embodiment include two types, “Auto” and “EAP.” Auto, which is a first authentication type, means mutual authentication is conducted between the switch 100 and the external device connected thereto, by using an authentication protocol determined in accordance with a predetermined condition. Details of those will be described later.

EAP, which is a second authentication type, means mutual authentication is conducted between the switch 100 and the external device connected thereto, by using a specific authentication protocol that is determined in advance. The authentication protocol that is actually used when the type of authentication is the specific authentication protocol, i.e., EAP, is stored inside the RAM 400 in advance. This specific authentication protocol is preferably one selected from EAP-MD5 (Extensible Authentication Protocol-message digest version 5), EAP-TLS (Extensible Authentication Protocol-Transport Layer Security), EAP-TTLS (Extensible Authentication Protocol-Tunneled Transport Layer Security), PEAP (Protected Extensible Authentication Protocol), LEAP (Lightweight Extensible Authentication Protocol), and EAP-FAST (Extensible Authentication Protocol-Flexible Authentication via Secure Tunneling) of IEEE (Institute of Electrical and Electronics Engineers) 802.1X. In the present embodiment, the authentication is conducted by using EAP-MD5. A user may be given an ability to configure this specific authentication protocol.

It should be noted that the authentication protocol list 410 may include a type of authentication other than the types of authentication shown in the above described example (e.g., “Open” which means there will be no authentication conducted for the external device connected to the switch 100).

Stored in the MAC authentication field are setting values to “enable” or “disable” a MAC address authentication; and the setting values are predetermined for each of the ports whose identifiers are stored in the port number field. It should be noted that the MAC authentication field can be omitted. When the MAC authentication field is omitted, it is preferable from a standpoint of improving security in the switch 100 that MAC address authentication is enabled for all the ports.

For example, in FIG. 3, it is specified that when the external device is connected to the port P501 which is identified by an identifier P501, authentication based on Auto, i.e., authentication using an authentication protocol determined in accordance with a predetermined condition, will be conducted. In addition, it is specified that a MAC address authentication will be conducted on a frame received through the port P501 (entry E01). It is also specified that authentication based on EAP, i.e., authentication in accordance with EAP-MD5 authentication protocol, will be conducted when the external device is connected to the port P502 identified by an identifier P502. In addition, it is specified that MAC address authentication is conducted on a frame received through the port P502 (entry E02).

FIG. 4 is a chart presenting one example of the permission list 420. The permission list 420 is a list used when conducting MAC address authentication. A transmission source MAC address is a MAC address of a device that has transmitted a frame to the switch 100. Stored in the permission list 420 as permitted addresses are transmission source MAC addresses from which frames that will be permitted by the relay process section 210 of the switch 100 for relaying are received. Thus, the permission list 420 is configured such that a received frame eligible to be relayed can be identified by using the information included in the received frame.

For example, in FIG. 4, if the transmission source MAC address included in a header of a received frame is either “MAC_PC10” or “MAC_PC20”, relaying of the received frame will be permitted by the relay process section 210.

FIG. 5 is a chart presenting one example of the authentication protocol candidate list 450. The authentication protocol candidate list 450 includes an authentication process field and an authentication protocol field. Types of authentication processes that can be executed by the EAP authentication section 240 are stored in the authentication process field in advance. The types of authentication processes in the present embodiment are two types, “EAP_SW mode authentication process” and “EAP_PC mode authentication process.” The EAP_SW mode authentication process is an authentication process executed by the EAP authentication section 240 when a separate switch is connected to the switch 100. The EAP_PC mode authentication process is an authentication process executed by the EAP authentication section 240 when a device (e.g., terminal and the like) other than a switch is connected to the switch 100.

Stored in the authentication protocol field in advance are authentication protocols that are actually used in the respective authentication processes stored in the authentication process field. In the example in FIG. 5, it is specified that the EAP authentication section 240 conducts authentication by using EAP-TLS of IEEE 802.1X when the type of authentication process is the EAP_SW mode authentication process. In addition, it is specified that the EAP authentication section 240 conducts authentication by using EAP-MD5 of IEEE 802.1X when the type of authentication process is the EAP_PC mode authentication process. It should be noted that the authentication protocol field preferably includes at least one among EAP-MD5, EAP-TLS, EAP-TTLS, PEAP, LEAP, and EAP-FAST of IEEE 802.1X.

As described above, candidates of authentication processes executed by the EAP authentication section 240 and authentication protocols used in respective authentication processes are stored in the authentication protocol candidate list 450 in advance in a corresponding manner. Thus, a plurality of authentication protocol candidates are stored in the authentication protocol candidate list 450. A user may be given an ability to configure the content of the authentication protocol candidate list 450.

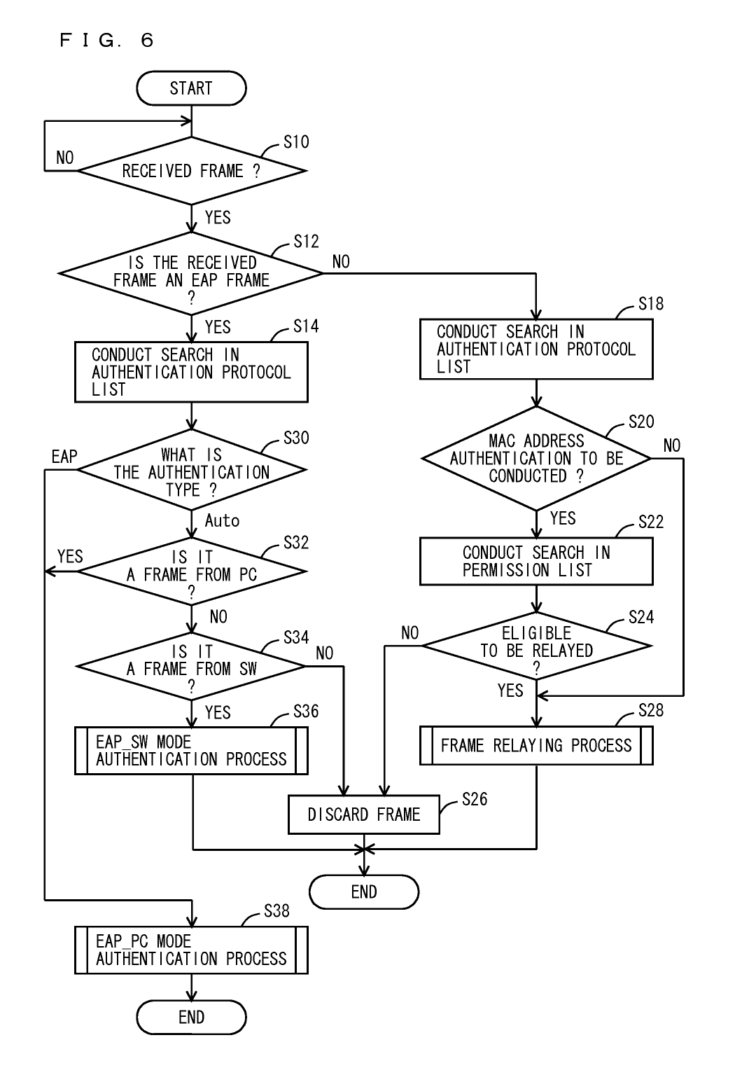

Described next is a process conducted by the switch 100 of the above described configuration upon receiving a frame. FIG. 6 is a flowchart showing a procedural sequence of processes of the process conducted by the network relay device (switch) 100 according to the first embodiment of the present invention upon receiving a frame.

First, the relay process section 210 determines whether a frame has been received through any one of the ports P501 to P505 (step S10). When a frame is received (step S10: YES), the relay process section 210 determines whether or not the received frame is an EAP frame (step S12). Specifically, for example, when the type of the received frame, which is determined from an EtherType included in the header of the received frame, is EAPOL (extensible authentication protocol over LAN); the relay process section 210 can determine that an EAP frame has been received.

When the received frame is determined to be an EAP frame (step S12: YES), the EAP authentication section 240 conducts a search in the authentication-type field of the authentication protocol list 410 (step S14). Specifically, the EAP authentication section 240 refers to the authentication protocol list 410, and acquires the value in the authentication-type field from the entry that has, in the port number field, the identifier of the port through which the frame has been received. The EAP authentication section 240 determines whether the acquired value in the authentication-type field is “EAP” or “Auto” (step S30). When the value in the authentication-type field is “EAP” (step S30: EAP), the EAP authentication section 240 conducts the EAP_PC mode authentication process (step S38). Details of the EAP_PC mode authentication process will be described later.

On the other hand, when the value in the authentication-type field is “Auto” (step S30: Auto), the EAP authentication section 240 determines whether or not the received frame is a frame from a terminal (step S32). Specifically, for example, the EAP authentication section 240 refers to a payload in the received EAP frame, and when the identifier included in a predetermined position of the payload is a value indicating a terminal, the EAP authentication section 240 determines that the received frame is from a terminal. When the received frame is a frame from a terminal (step S32: YES), the EAP authentication section 240 conducts the EAP_PC mode authentication process (step S38).

When the received frame is not a frame received from a terminal (step S32: NO), the EAP authentication section 240 determines whether or not the received frame is a frame from a switch (step S34). Specifically, for example, the EAP authentication section 240 refers to the payload in the received EAP frame, and when the identifier included in a predetermined position of the payload is a value indicating a switch, the EAP authentication section 240 determines that the received frame is from a switch. When the received frame is a frame from a switch (step S34: YES), the EAP authentication section 240 conducts the EAP_SW mode authentication process (step S36). Details of the EAP_SW mode authentication process will be described later. On the other hand, when the received frame is not a frame from a switch (step S34: NO), the EAP authentication section 240 discards the received frame and ends the process (step S26).

As described above, the EAP authentication section 240 determines the type of authentication that the port through which the frame is received (in other words, a port having an external device connected thereto) is configured for, and determines the authentication process in accordance with the determined type of authentication (step S30).

On the other hand, when the received frame is determined as not being an EAP frame (step S12: NO), the MAC address authentication section 230 conducts a search in the MAC authentication field of the authentication protocol list 410 (step S18). Specifically, the MAC address authentication section 230 refers to the authentication protocol list 410, and acquires the value in the MAC authentication field from the entry that has, in the port number field, the identifier of the port through which the frame has been received; more specifically, acquires a setting value to “enable”/“disable” the MAC address authentication. Next, the MAC address authentication section 230 determines whether or not to conduct a MAC address authentication based on the acquired setting value (step S20). Specifically, the MAC address authentication section 230 conducts the MAC address authentication if the acquired setting value is “enable,” and does not conduct the MAC address authentication if the acquired setting value is “disable.” When the MAC address authentication is not being conducted (step S20: NO), the MAC address authentication section 230 conducts a frame relaying process (step S28).

When it is determined to conduct the MAC address authentication (step S20: YES), the MAC address authentication section 230 refers to the permission list 420 (step S22), and determines whether or not the received frame is eligible to be relayed (step S24). Specifically, the MAC address authentication section 230 determines whether or not the transmission source MAC address included in the header of the received frame matches any one of the MAC addresses stored in the permission list 420. When there are no matches in the MAC addresses and when it is determined that the received frame is not eligible to be relayed (step S24: NO), the MAC address authentication section 230 discards the received frame and ends the process (step S26). After discarding the received frame, the MAC address authentication section 230 may notify the source terminal from which the discarded frame has been transmitted about the discarding of the frame.

On the other hand, when it is determined not to conduct the MAC address authentication at step S20 described above (step S20: NO), and when there is a match in the MAC addresses and it is determined that the received frame is eligible to be relayed at step S24 described above (step S24: YES), the MAC address authentication section 230 conducts a frame relaying process (step S28). In this frame relaying process, the relay process section 210 refers to a MAC address table which is not shown, and conducts forwarding (a frame relaying operation conducted when a destination MAC address is in the MAC address table) or flooding (an operation conducted when the destination MAC address is not in the MAC address table), and then ends the process. As described above, the MAC address authentication section 230 of the relay process section 210 determines whether the received frame is eligible to be relayed based on the permission list 420.

### 1. Specific Example 1 of Process Conducted upon Frame Reception

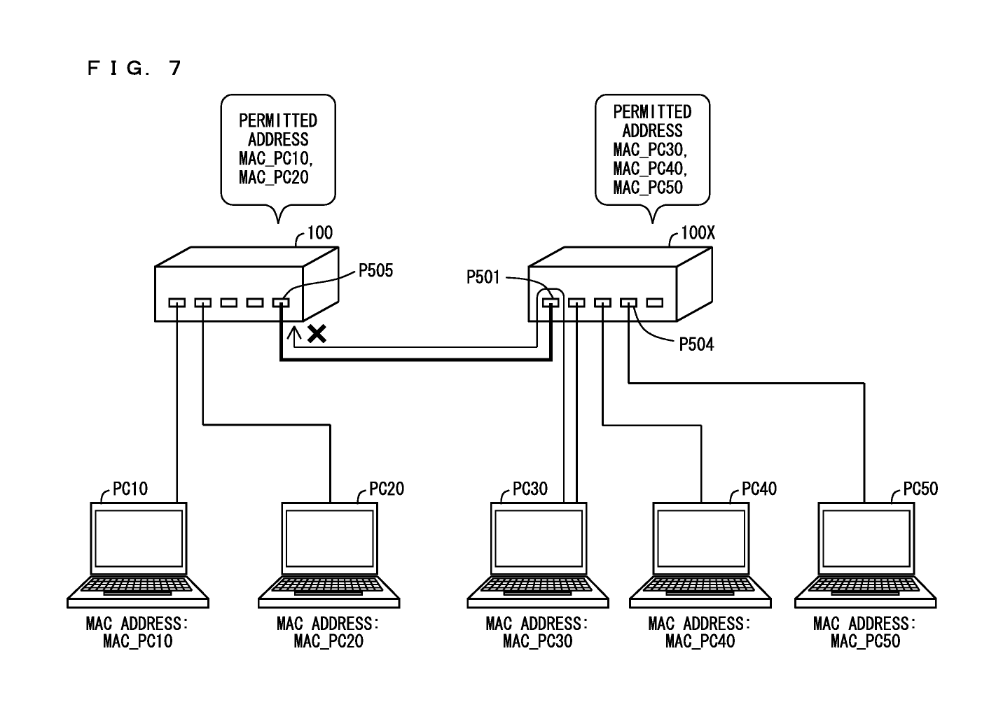

A specific example 1 of a process conducted by the switch 100 upon receiving a frame will be described in the following by further referring to FIG. 7 to FIG. 9. FIG. 7 to FIG. 9 show an example where a new external device (another switch 100X, via port P501) is connected to the port P505 of the switch 100. The configuration of the other switch 100X is similar to that of the switch 100 shown in FIG. 2, except that the port P501 is configured as a port for cascade connection. With regard to ports of the other switch 100X, the port P501 has the port P505 of the switch 100 connected thereto, the port P502 has a terminal PC30 connected thereto, the port P503 has a terminal PC 40 connected thereto, the port P504 has a terminal PC50 connected thereto, and all connections are formed via lines. In addition, the MAC address of the terminal PC30 is MAC_PC30, the MAC address of the terminal PC 40 is MAC_PC40, and the MAC address of the terminal PC50 is MAC_PC50. Stored in the permission list (referred to as a second permission list in this specific example) 420 included in the other switch 100X are the MAC addresses (MAC_PC30, MAC_PC40, and MAC_PC50) of the three terminals (PC30, PC40, and PC50) connected to the other switch 100X. Descriptions of the authentication protocol list 410 included in the other switch 100X is omitted. Furthermore, the terminals connected to each of the ports of the switch 100, and the authentication protocol list 410 and the permission list (referred to as a first permission list in this specific example) 420 included in the switch 100 are as shown in FIG. 1, FIG. 3, and FIG. 4.

### 1-1. Prior to having Mutual Authentication Conducted between the Switches

Described in the following as an example is a case as shown in FIG. 7 where a frame is transmitted from the terminal PC30 to the terminal PC20 prior to having mutual authentication conducted between the switch 100 and the other switch 100X. First, the other switch 100X detects a frame received from the terminal PC30 (step S10 in FIG. 6: YES). Since the received frame that has been detected is not an EAP frame (step S12: NO), the other switch 100X refers to the authentication protocol list 410 and determines that the MAC address authentication is enabled at the port P502 that received the frame (step S18, step S20). Next, the other switch 100X verifies that MAC_PC30, which is a transmission source MAC address, matches a MAC address stored in the second permission list 420, and determines that the received frame is eligible to be relayed (step S22, step S24: YES). Then, the other switch 100X conducts a frame relaying process (step S28). As a result, the frame received by the other switch 100X is transmitted from the port P501 of the other switch 100X to the switch 100.

The switch 100 that received the frame from the other switch 100X (step S10 in FIG. 6: YES) determines that the received frame is not an EAP frame (step S12: NO). Next, the switch 100 refers to the authentication protocol list 410, and determines that the MAC address authentication is enabled at the port P505 through which the frame has been received (step S18, step S20). However, the switch 100 verifies that MAC_PC30, which is the transmission source MAC address, does not match any of the MAC addresses stored in the first permission list 420, and determines that the received frame is not eligible to be relayed (step S22, step S24: NO). As a result, the frame received by the switch 100 via the other switch 100X is discarded by the switch 100 (step S26).

As described above, prior to having mutual authentication conducted between the switch 100 and the other switch 100X, the switch 100 does not relay a frame received from an external device connected to the other switch 100X, and discards the frame. In other words, prior to having mutual authentication conducted with the other switch 100X, the switch 100 restricts input of traffic from the other switch 100X. This occurs when a MAC address of an external device (the terminal PC30 to the terminal PC50) connected to the other switch 100X is not stored in the first permission list 420 included in the switch 100.

### 1-2. Authentication Process between the Switches (EAP_SW Mode Authentication Process)

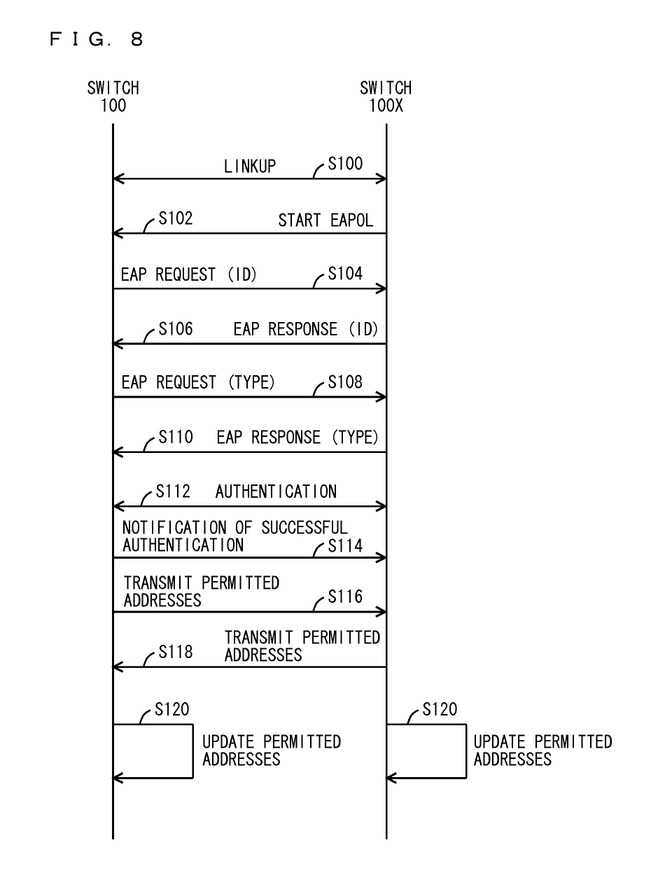

Mutual authentication between the switch 100 and the other switch 100X is conducted as described in the following. FIG. 8 is a sequence diagram showing a flow of the EAP_SW mode authentication process (step S36 in FIG. 6).

When the other switch 100X is connected to the switch 100, a linkup is conducted between the two switches at the beginning (step S100). Next, an EAPOL-start (EAP over LAN-Start) frame for requesting a start of authentication is transmitted from the other switch 100X acting as a supplicant to the switch 100 acting as an authenticator (step S102).

The EAP authentication section 240 of the switch 100 which has received the EAPOL start frame determines that the received frame is an EAP frame. In addition, the EAP authentication section 240 refers to the authentication protocol list 410, and determines that the type of authentication of the port P505 through which the EAP frame is received is “Auto,” and that the EAP frame is a frame received from a switch based on the identifier included in a predetermined position of the payload, i.e., that the authentication process is the EAP_SW mode authentication process. The EAP authentication section 240 transmits, to the other switch 100X, an EAP request frame requesting an ID of the supplicant (step S104). The other switch 100X that has received the request frame transmits an EAP response frame including the ID of the supplicant to the switch 100 (step S106). Next, the EAP authentication section 240 of the switch 100 transmits, to the other switch 100X, the EAP request frame for notifying the type of EAP to be used for the authentication (step S108). Specifically, the EAP authentication section 240 refers to the authentication protocol candidate list 450, and acquires a value “EAP-TLS” in the authentication protocol field from the entry that has, in the authentication process field, the EAP_SW mode authentication process obtained as a result of the judgment. Then, the EAP authentication section 240 transmits, to the other switch 100X, the EAP request frame including an identifier of the acquired authentication protocol EAP-TLS. The other switch 100X which has received the request frame transmits, to the switch 100, the EAP response frame including the identifier of the type (EAP-TLS) of EAP used for the authentication (step S110).

Then, mutual authentication conforming to the authentication protocol “EAP-TLS” announced at step S110 is conducted between the switch 100 and the other switch 100X (step S112). When the authentication has succeeded, the EAP authentication section 240 of the switch 100 transmits, to the other switch 100X, an EAP frame regarding the success of the authentication (step S114). It should be noted that each of the frames described above has a configuration conforming to the format predetermined by the rules of EAP; and the values of IDs, types, and the like are transmitted and received as data stored in specified positions within the frames.

After the success of the authentication, the authentication information management section 220 of the switch 100 transmits a frame including permitted addresses stored in the first permission list 420 to the other switch 100X (step S116). The other switch 100X that has received this frame transmits, to the switch 100, a frame including permitted addresses stored in the second permission list 420 of the other switch 100X (step S118). Lastly, the authentication information management section 220 of the switch 100 updates the permitted addresses stored in the first the permission list 420 of the switch 100 based on the permitted addresses included in the received frame. Specifically, the authentication information management section 220 adds the permitted addresses (MAC addresses) included in the received frame to the first permission list 420. Similarly, the other switch 100X updates the permitted addresses stored in the second permission list 420 of the other switch 100X based on the permitted addresses included in the received frame.

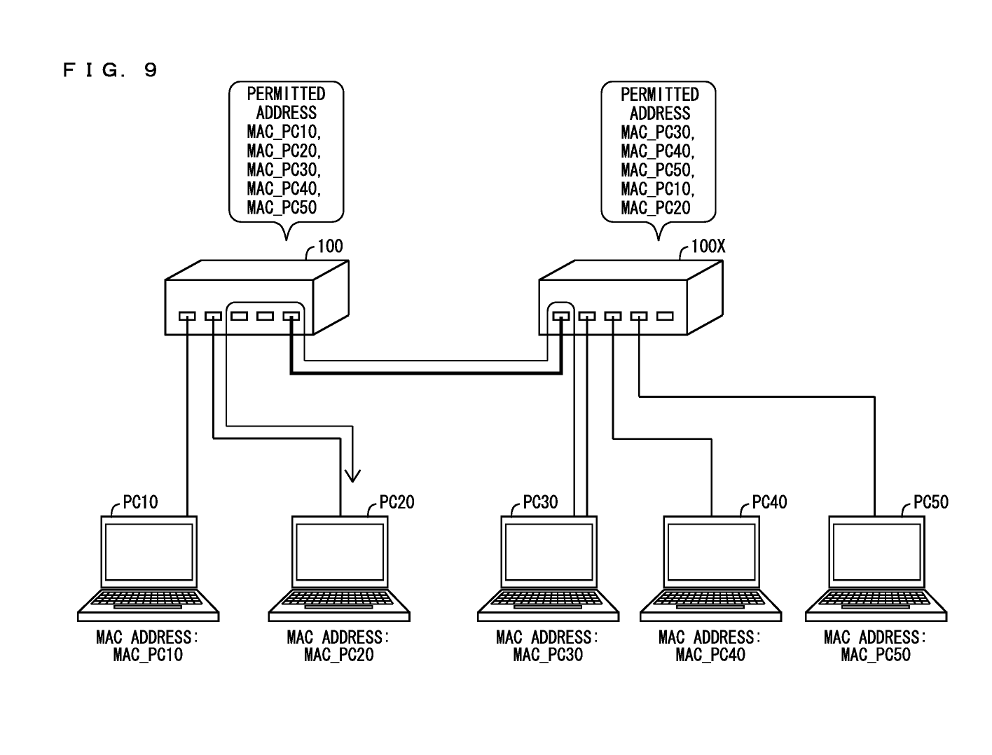

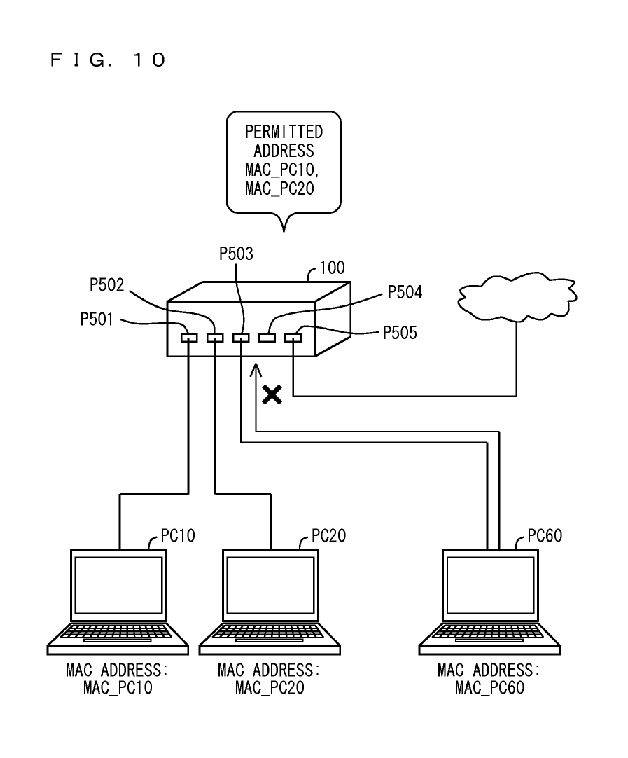

In this example, in addition to the permitted addresses (MAC_PC10 and MAC_PC20) of the two terminals (PC10 and PC20) connected to the switch 100, permitted addresses (MAC_PC30, MAC_PC40, and MAC_PC50) stored in the second permission list 420 included in the other switch 100X are stored in the first permission list 420 included in the switch 100 (FIG. 9). Similarly, in addition to the MAC addresses (MAC_PC30, MAC_{'}PC40, and MAC_PC50) of the three terminals (PC30, PC40, and PC50) connected to the other switch 100X, the permitted addresses (MAC_PC10 and MAC_PC20) stored in the first permission list 420 included in the switch 100 are stored in the second permission list 420 included in the other switch 100X (FIG. 9).

It should be noted that steps S116 to S120 in FIG. 8 may be omitted. When steps S116 to S120 are to be omitted, they may be substituted with, for example, processes described in the following.

A process is conducted for storing, in a specific storage section (e.g., the RAM 400 or the like) in the switch 100, information indicating that authentication of the other switch 100X connected to the port P505 has been conducted.

A process is conducted for newly adding the permission list 420 and permitting relaying of frames, if the transmission source MAC address, which is included in the header of the frame received through the port P505 which has been authenticated, is not in the permission list 420 at step S22 in the process (FIG. 6) conducted upon receiving a frame.

In FIG. 8, although the other switch 100X functions as an authentication client (supplicant) based on IEEE 802.1X and the switch 100 functions as an authentication server (authenticator) based on IEEE 802.1X, the functions may be reversed. For example, a configuration can be adopted where the switch 100 transmits an EAPOL-start frame to the other switch 100X when the switch 100 does not receive an EAPOL-start frame within a certain period of time after detecting the linkup (step S100). In this case, the switch 100 functions as an authentication client and the other switch 100X functions as an authentication server. As described here, if the EAP authentication section 240 functions both as an authentication client based on IEEE 802.1X and an authentication server based on IEEE 802.1X, the switch 100 can behave as an authentication client and an authentication server with respect to the other switch 100X, and thereby a highly flexible authentication can be conducted.

### 1-3. After having Mutual Authentication Conducted between the Switches

As shown in FIG. 9, described in the following is a case where a frame is transmitted from the terminal PC30 to the terminal PC20 after mutual authentication is conducted between the switch 100 and the other switch 100X. In this case, the flow of the process up to the transmission of the frame from the terminal PC30 to the switch 100 via the other switch 100X is identical to that described in FIG. 7.

The switch 100 receiving the frame from the other switch 100X (step S10 in FIG. 6: YES) determines that the received frame is not an EAP frame (step S12: NO). Next, the switch 100 refers to the authentication protocol list 410, and determines that the MAC address authentication is enabled at the port P505 through which the frame has been received (step S18, step S20). Furthermore, the switch 100 verifies that MAC_PC30, which is the transmission source MAC address, matches a MAC address stored in the first permission list 420, and determines that the received frame is eligible to be relayed (step S22, step S24: YES). Then, the switch 100 conducts the frame relaying process (step S28). As a result, the frame received by the switch 100 via the other switch 100X is transmitted from the port P502 of the switch 100 to the terminal PC20.

As described above, if mutual authentication between the switch 100 and the other switch 100X is conducted and when the mutual authentication has succeeded, the switch 100 relays a frame received from an external device connect to the other switch 100X. In other words, on a condition that the mutual authentication has succeeded with the other switch 100X, the switch 100 does not restrict input of traffic from the other switch 100X.

### 2. Specific Example 2 of the Process Conducted upon Frame Reception

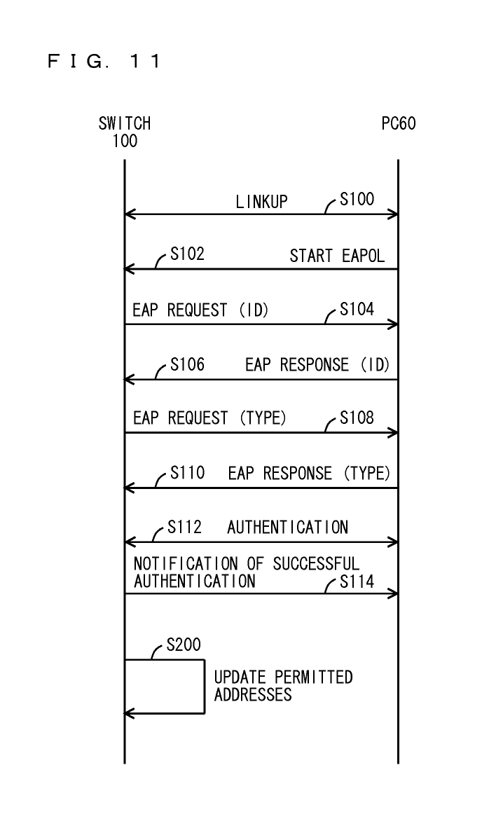

A specific example 2 of the process conducted by the switch 100 upon receiving a frame will be described in the following by further referring to FIG. 10 to FIG. 12. FIG. 10 to FIG. 12 show an example where a new external device (terminal PC60; MAC address of MAC_PC60) is connected to the port P503 of the switch 100.

### 2-1. Prior to having Mutual Authentication Conducted between the Switch and the Terminal

Described in the following is a case as shown in FIG. 10 where a frame is transmitted from the terminal PC60 to the switch 100 before having mutual authentication conducted between the switch 100 and the terminal PC60. In this case, since the received frame is not an EAP frame and a matching permitted address is not stored in the permission list 420, the MAC address authentication section 230 of the switch 100 discards the frame from the terminal PC60 received by the switch 100 as described in FIG. 7 (step S26 in FIG. 6).

### 2-2. Authentication Process between the Switch and the Terminal (EAP_PC Mode Authentication Process)

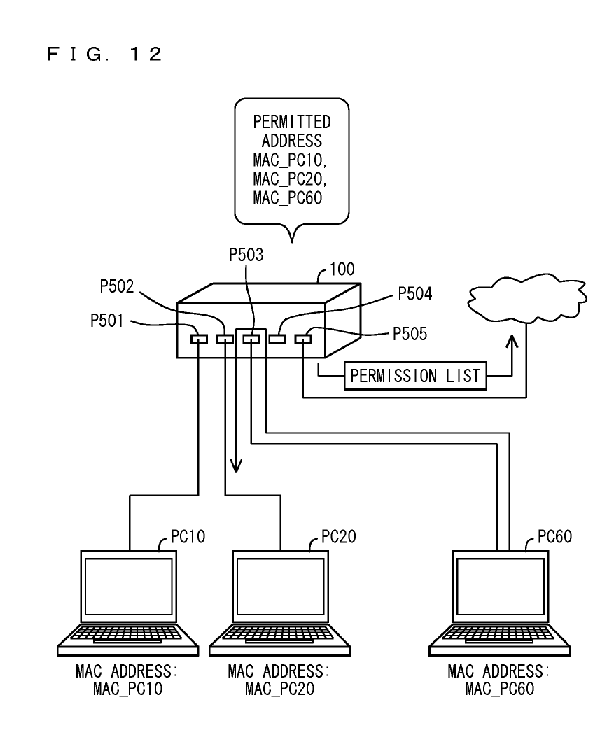

Mutual authentication between the switch 100 and the terminal PC60 is conducted as described in the following. FIG. 11 is a sequence diagram showing a flow of the EAP_PC mode authentication process (step S38 in FIG. 6).

When the terminal PC60 is connected to the switch 100, a linkup is conducted between the two at the beginning (step S100). Next, an EAPOL start (EAP over LAN-Start) frame is transmitted from the terminal PC60 acting as a supplicant to the switch 100 acting as an authenticator (step S102).

The EAP authentication section 240 of the switch 100, which has received the EAPOL start frame, determines that the received frame is an EAP frame. In addition, the EAP authentication section 240 refers to the authentication protocol list 410, and determines that the type of authentication of the port P503 through which the EAP frame is received is “Auto,” and that the EAP frame is a frame received from a terminal, based on the identifier included in a predetermined position of the payload, i.e., that the authentication process is the EAP_PC mode authentication process. The EAP authentication section 240 transmits, to the terminal PC60, an EAP request frame requesting an ID of the supplicant (step S104). The terminal PC60 that has received the request frame transmits, to the switch 100, an EAP response frame including the ID of the supplicant (step S106). Next, the EAP authentication section 240 of the switch 100 transmits, to the terminal PC60, the EAP request frame for notifying the type of EAP to be used for the authentication (step S108). Specifically, the EAP authentication section 240 refers to the authentication protocol candidate list 450, and acquires a value “EAP-MD5” in the authentication protocol field from the entry that has, in the authentication process field, the EAP_PC mode authentication process obtained as a result of the judgment. Then, the EAP authentication section 240 transmits, to the terminal PC60, the EAP request frame including an identifier of the acquired authentication protocol EAP-MD5. The terminal PC60 which has received the request frame transmits, to the switch 100, the EAP response frame including the identifier of the type (EAP-MD5) of EAP used for the authentication (step S110).

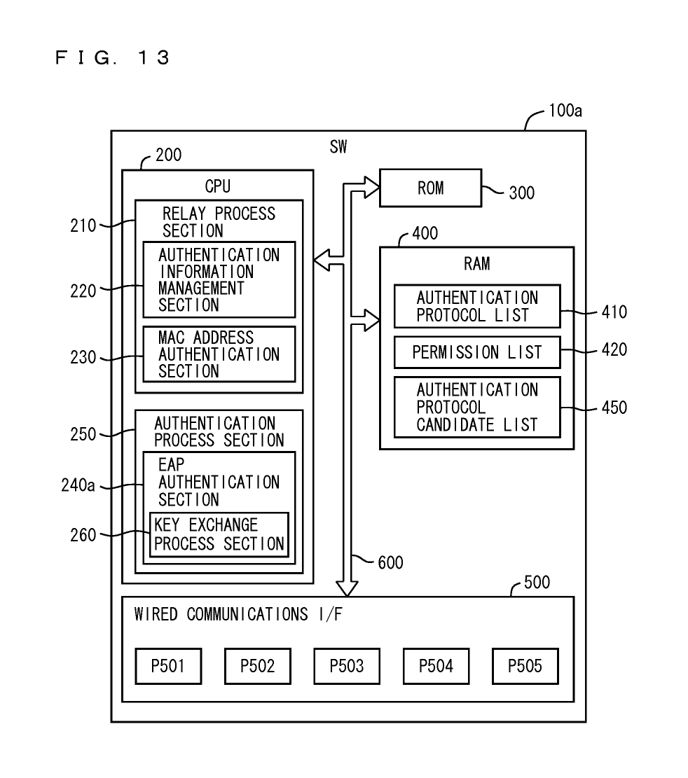

Then, mutual authentication conforming to the authentication protocol “EAP-MD5” notified at step S110 is conducted between the switch 100 and the terminal PC60 (step S112). When the authentication has succeeded, the EAP authentication section 240 of the switch 100 transmits, to the terminal PC60, an EAP frame regarding the success of the authentication (step S114). When the authentication at step S112 has succeeded, the authentication information management section 220 of the switch 100 adds the MAC address (MAC_PC60) of the terminal PC60 to the permitted addresses stored in the permission list 420 to update the permitted addresses (step S200). In this example, the MAC address (MAC_PC60) of the terminal PC60 which has been newly connected to the switch 100 is stored in the permission list 420 included in the switch 100, in addition to the permitted addresses (MAC_PC10 and MAC_PC20) of the two terminals (PC10 and PC20) that are already connected to the switch 100 (FIG. 12).

### 2-3. After having Mutual Authentication Conducted between the Switch and the Terminal

Described in the following is a case as shown in FIG. 12 where a frame is transmitted from the terminal PC60 to the terminal PC20 after having mutual authentication conducted between the switch 100 and the terminal PC60.

The switch 100 that received the frame from the terminal PC60 (step S10 in FIG. 6) determines that the received frame is not an EAP frame (step S12: NO). Next, the switch 100 refers to the authentication protocol list 410, and determines that the MAC address authentication is enabled at the port P503 through which the frame has been received (steps S18, S20). Furthermore, the switch 100 verifies that MAC_PC60, which is the transmission source MAC address, matches a MAC address stored in the permission list 420, and determines that the received frame is eligible to be relayed (steps S22 and S24: YES). Then, the switch 100 conducts the frame relaying process (step S28). As a result, the frame from the terminal PC60 received by the switch 100 is transmitted from the port P502 of the switch 100 to the terminal PC20.

For example, when the switch 100 is connected to still another switch, the switch 100 may transmit, to the still another switch, the frame including the permitted addresses stored in the updated permission list 420. As a result of spreading the updated permitted addresses to other switches connected to a switch, the content of the permission list that is to be used in the MAC address authentication (i.e., MAC addresses of external devices from which frames should be permitted for relaying) can be exchanged between switches, and thereby a further improvement in convenience can be achieved. The permitted addresses may be spread to switches within a range of a single segment demarked by a router. The permitted addresses may be spread to the router itself. Then, the MAC addresses can be managed also by the router.

As described above, the switch 100 relays frames received from the terminal PC60 if mutual authentication is conducted between the switch 100 and the terminal PC60 and if the authentication has succeeded. In other words, on a condition that the authentication with the terminal PC60 has succeeded, the switch 100 does not limit input of traffic from the terminal PC60.

As described above, in the switch 100 according to the first embodiment of the present invention, an authentication process (EAP_PC mode authentication process, EAP_SW mode authentication process, or the like) that should be executed and an authentication protocol designated for the authentication process are determined in accordance with the type of authentication predetermined for a port (Auto, EAP, or the like), the type of a received frame (EAP frame, or the like), and the type (switch, terminal, or the like) of an external device which is a transmission source of the received frame.

In particular, on a frame received through a port to which “Auto” is set as the type of authentication, an authentication is conducted using an authentication protocol in accordance with the type of an external device connected to the port. Therefore, when “Auto” is set as the type of authentication for each of the ports of the switch 100, it becomes unnecessary for an administrator of the switch 100 to be conscious of the types of the external devices connected to each of the ports of the switch 100, and the switch can flexibly deal with changes in the network configuration.

Furthermore, the switch 100 limits input of traffic from an external device prior to conducting mutual authentication between the switch 100 and the external device, and the switch 100 does not limit input of traffic from the external device if the mutual authentication between the switch 100 and the external device has succeeded. As a result, the switch 100 capable of flexibly dealing with changes in the network configuration while ensuring security can be provided.

Furthermore, for a frame received through a port to which “EAP” is set as the type of authentication, the switch 100 conducts mutual authentication between the switch 100 and an external device by using a predetermined specific authentication protocol (EAP-MD5 or the like) that is in the RAM 400. Therefore, for example, a request of using a predetermined authentication protocol for a specific port can be accommodated. As a result, the switch 100 can achieve both convenience and improvement in security.

Furthermore, when an external device is connected to the switch 100 and if the authentication process has succeeded, the (first) permission list 420 is changed so as to allow relaying of a frame received from the external device. Therefore, an improvement in security can be achieved for the switch 100. In addition, when the permission list 420 is changed, since the switch 100 transmits the content of the permission list 420 to other switches connected to the switch 100, improvement in convenience can be achieved.

### Second Embodiment

Described in a second embodiment of the present invention is a configuration further including a process of exchanging keys used for authentication in the network relay device (switch) 100 of the first embodiment. In the following, descriptions of the second embodiment are provided only for those having a configuration or operation that is different from the first embodiment. It should be noted that, in the figures used for the second embodiment, components identical to those in the first embodiment are given reference characters identical to those in the first embodiment, and detailed descriptions of those are omitted.

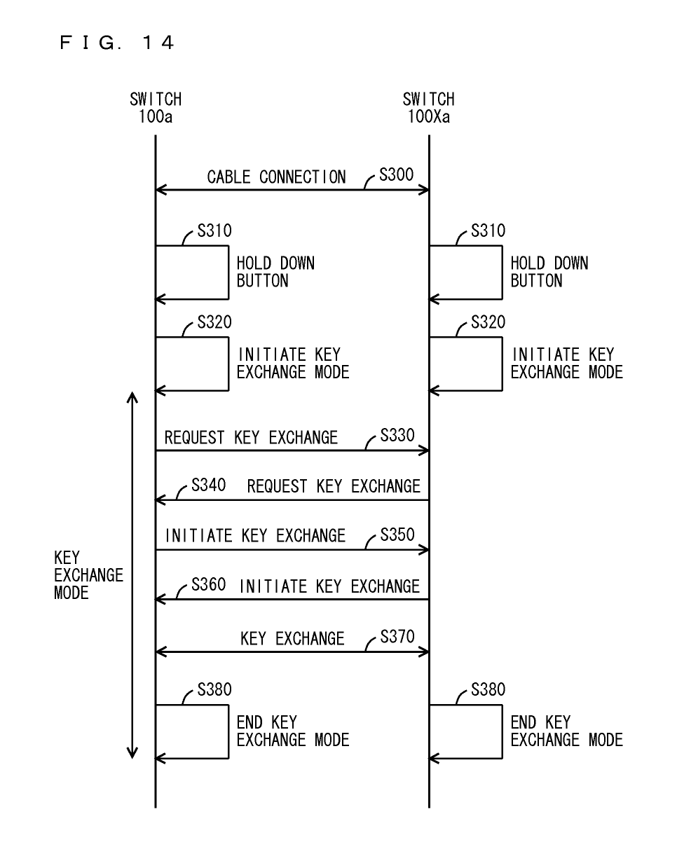

FIG. 13 is a diagram schematically representing a configuration of a network relay device (switch) 100a according to the second embodiment of the present invention. The switch 100a according to the second embodiment differs from the switch 100 according to the first embodiment shown in FIG. 2 with regard to an EAP authentication section 240a including a key exchange process section 260. Thus, when compared to the processes described for the switch 100 according to the first embodiment, only the key exchange process described in the following is different in the switch 100a according to the second embodiment.

The key exchange process section 260 includes a function of exchanging shared keys (secret keys) used in an authentication process conducted by the EAP authentication section 240a. The authentication process conducted by the EAP authentication section 240a refers to the EAP_SW mode authentication process described in FIG. 8 and to the EAP_PC mode authentication process described in FIG. 11. Needless to say that even when the EAP authentication section 240a uses an authentication protocol (e.g., WPA, other original authentication protocols, and the like) other than authentication protocols conforming to EAP protocol of IEEE 802.1X, the key exchange process section 260 can exchange shared keys for use in the other authentication protocol as conducted similarly in an authentication protocol conforming to EAP protocol.

FIG. 14 is a sequence diagram showing a flow of the key exchange process conducted by the switch 100a.

First, if another switch 100Xa is connected to the switch 100a via a wire, both of these switches detect the wired connection (step S300). It should be noted that the switch 100a and the other switch 100Xa are identical to those described in FIG. 7, except for the above described difference (FIG. 13).

Next, the switch 100a determines whether or not an instruction has been given by the user to initiate exchanging of shared keys. The instruction to initiate exchanging of shared keys is determined, for example, when an operation of holding down a button (not shown) disposed on the switch 100a is detected (step S310). After holding down of the button is detected, the key exchange process section 260 of the switch 100a initiates a key exchange mode of the switch 100a (step S320). Specifically, the key exchange process section 260 of the switch 100a stops the relay process (FIG. 6) of a received frame conducted by the relay process section 210, and acquires a received frame instead of the relay process section 210. The processes at steps S310 and S320 are also executed similarly in the other switch 100Xa.

In the key exchange mode, the key exchange process section 260 of the switch 100a transmits, to the other switch 100Xa, a key-exchange frame requesting an exchange of keys (step S330). On the other hand, the other switch 100Xa also transmits, to the switch 100a, a key-exchange frame requesting an exchange of keys (step S340). The key exchange process section 260 of the switch 100a, which has received the key-exchange frame from the other switch 100Xa, transmits to the other switch 100Xa an initiation request frame for initiating the exchange of keys (step S350). In addition, the other switch 100Xa also transmits to the switch 100a an initiation request frame for initiating the exchange of keys (step S360). It should be noted that the order of steps S330 and S340, and the order of steps S350 and S360 may be reversed.

Then, the key exchange process for exchanging shared keys between the switch 100a and the other switch 100Xa is conducted (step S370). The key exchange process can be conducted by using any key exchange method, and, for example, Diffie-Hellman key exchange (DH method) can be used. As a result of the key exchange process, secret keys are transmitted and received between the switch 100a and the other switch 100Xa.

After the key exchange process ends, the key exchange process section 260 of the switch 100a ends the key exchange mode (step S380). Specifically, the key exchange process section 260 of the switch 100a stops acquiring a received frame, which has been conducted instead of the relay process section 210, and restarts the relay process of a received frame conducted by the relay process section 210 (FIG. 6). The process at step S380 is also executed in the other switch 100Xa.

With this, the key exchange mode ends. Since relaying of frames by the relay process section 210 is stopped during the key exchange mode, the switch 100a preferably performs a display (an LED display or the like) to call attention of the user.

Although the execution of the above described key exchange process is triggered by the operation of holding down the button or the like (step S310), the operation of holding down the button is merely one example and any operation may be adopted. In addition, in the second embodiment, descriptions have been provided by using the other switch 100Xa as an example of an external device conducting the key exchange process with the switch 100a. However, a key exchange process similar to that in FIG. 14 can be conducted even when a terminal is connected as the external device.

As described above, in the switch 100a according to the second embodiment of the present invention, in response to a generation of a predetermined operation (holding down a button or the like), the relaying of received frames by the relay process section 210 is stopped and the key exchange process is conducted. As a result, shared keys (secret keys) used for mutual authentication between the switch 100a and an external device can be exchanged.

### Modification 1

The configurations of the switches shown in each of the embodiment described above are merely examples and other configurations may be adopted. For example, as described in the following, modifications such as an omission of a part of the components and a further addition of components can be devised.

Instead of using layer 2 switches to relay frames by using MAC addresses, the switches in each of the embodiments may be layer 3 switches that are further capable of relaying packets by using IP addresses. Furthermore, the switches in each of the embodiments may be so-called access points capable of relaying packets of wireless communication via wireless-communication interfaces.

Furthermore, the switches of each of the above described embodiments may further include, for example, a VLAN function for building virtual subnetworks, a link aggregation function for logically combining a plurality of ports to be handled as a one, and the like.

Furthermore, although the authentication protocol list, the permission list, and the authentication protocol candidate list are stored in a RAM in the switches of the above described embodiments, they may be stored in other storage media (e.g., flash ROM).

Furthermore, descriptions have been provided for the switches in each of the above described embodiments as, the CPU including the relay process section and the EAP authentication section, the relay process section including the authentication information management section and the MAC address authentication section, and further, the EAP authentication section including the key exchange process section. In addition, descriptions of the functions executed in each of the process sections have been provided. However, the allocations of each of the process sections and the functions accomplished by each of the process sections are merely examples, and can be arbitrarily changed depending on the configuration of the switch.

Furthermore, among the functions of the relay process section described in the embodiments, the frame relaying function may be a function attained by a physical chip that forms a wired communications interface, and the other functions (the function of determining whether a received frame is eligible to be relayed, the function of the authentication information management section, and the function of the MAC address authentication section) of the relay process section may be functions attained by the CPU. In such a case, all the functions of the relay process section are attained through a cooperation of the CPU and the physical chip forming the wired communications interface. For example, the functions of the relay process section, the EAP authentication section, the authentication information management section, the MAC address authentication section, and the key exchange process section may all be included inside the physical chip forming the wired communications interface.

### Modification 2

In the embodiments described above, the switch includes: the MAC address authentication section for conducting a MAC address authentication of a received frame; and the EAP authentication section for conducting, when an external device is connected, mutual authentication between the switch and the connect external device. In other words, a function of RADIUS (Remote Authentication Dial-In User Service) is built in the switch. However, a dedicated RADIUS server may be provided separate from the switch, and this external RADIUS server may conduct the actual MAC address authentication and the mutual authentication with a connected external device. When a dedicated RADIUS server separate from the switch is provided, the functions of the MAC address authentication section and the EAP authentication section can be achieved by having the MAC address authentication section and the EAP authentication section transmit authentication requests to the RADIUS server to obtain authentication results as responses to the transmissions.

### Modification 3

In the above described embodiments, examples of the authentication protocol list, the permission list, and the authentication protocol candidate list have been shown in a table format. However, these tables are merely examples, and the format thereof may be arbitrarily determined without departing from the spirit and scope of the invention. For example, fields other than the fields described above may be included. In addition, direct-mapped method can be used on each of the tables. Furthermore, it is also desirable if each of the tables is configurable by the user.

Specifically, although the permission lists only store, without any distinctions of the port through which a frame has been received, transmission source MAC addresses that are eligible to be relayed; modifications as described in the following may be adopted. For example, by adding the port number field to the permission list, the transmission source MAC addresses, from which frames permitted to be relayed are received, may be managed by every port. Furthermore, by providing a transmission source MAC address field and a relay-eligibility field instead of the permitted address field, a frame's eligibility/ineligibility to be relayed may be set for every transmission source MAC address.

### Modification 4

In each of the above described embodiments, in the process conducted upon receiving a frame (FIG. 6), descriptions of an example have been provided for each of the methods conducted by the relay process section and the EAP authentication section to identify the type of a frame (EAP frame or the like) and the type of a frame-transmitting-source device (terminal, switch, or the like). However, the methods described in the above described embodiments are merely examples, and any method can be adopted.

For example, at steps S32 and S34 in the process conducted upon receiving a frame (FIG. 6), instead of referring to the payload of the received EAP frame, the EAP authentication section may receive a response frame (step S106 in FIG. 8) that includes an ID of the supplicant and that is transmitted from an external device which is a connection partner, and may refer to identification information included in the response frame. With this, even when a frame that does not include an identifier in the payload of the EAP frame is received, the EAP authentication section can identify the type of an external device which is the source transmitting the frame; and thereby results in improved versatility. It should be noted that, in this case, a process of transmitting/receiving an EAP frame including an ID, is added between step S30 and step S32 in the process conducted upon receiving a frame (FIG. 6). In addition, the EAP_SW mode authentication process (FIG. 8) and the EAP_PC mode authentication process (FIG. 11) are initiated at step S108.

It should be noted that, in each of the embodiments described above, although the CPU has achieved every configuration of the switch by executing a firmware or a computer program stored in a memory, each configuration of the present invention may be achieved by hardware or software.

Furthermore, when one part or all the functions of the present invention are achieved by software, the software (computer program) may be provided as being stored in a computer readable storage medium. In the present invention, the term “computer readable storage medium” is not limited to portable storage media such as flexible disks and CD-ROMs, but also includes internal storage devices of computers such as various RAMs, ROMs, and the like, and external storage devices such as hard disks and the like that are fixed on the computer.

While the invention has been described in detail, the foregoing description is in all aspects illustrative and not restrictive. For example, elements that are additional in light of the scope and spirit of the present invention can be omitted as appropriate. It will be understood that numerous other modifications and variations can be devised without departing from the scope of the invention.

What is claimed is:

1. A network relay device for relaying data frames received from external devices, the network relay device comprising:
a plurality of ports to which external devices connect, and configured pre-correlated with types of authentication to be conducted with respect to connected external devices, the types of authentication including a first authentication type and a second authentication type;
an authentication process section for determining, when an external device is connected to the network relay device, the type of authentication that the port to which the external device is connected is configured for, and if the determined type of authentication is the first authentication type, conducting mutual authentication between the network relay device and the external device using an authentication protocol chosen from among a plurality of authentication protocol candidates in accordance with type of connected external device; and
a relay process section for relaying frames received from an external device with which authentication by the authentication process section has succeeded.

2. The network relay device according to claim 1, wherein if the authentication process section determines the authentication type to be the second authentication type, the authentication process section conducts mutual authentication between the network relay device and the external device using a predetermined authentication protocol, regardless of the type of connected external device.

3. The network relay device according to claim 1, wherein the authentication process section determines the type of a connected external device based on identifiers included in frames received from the external device.

4. The network relay device according to claim 1, wherein:
after an external device has been connected to the network relay device, the relay process section, in response to generation of a predetermined trigger, stops relaying frames received from the external device; and
if the authentication process section has received a key-exchange frame indicating that an exchange of keys used for authentication is being requested, the authentication process section conducts a process for exchanging keys with that external device which is connected to the port through which the key-exchange frame has been received.

5. The network relay device according to claim 1, wherein the plurality of authentication protocol candidates includes at least one authentication protocol among EAP-MD5, EAP-TLS, EAP-TTLS, PEAP, LEAP, and EAP-FAST.

6. The network relay device according to claim 2, wherein the predetermined authentication protocol is any one authentication protocol among EAP-MD5, EAP-TLS, EAP-TTLS, PEAP, LEAP, and EAP-FAST.

7. The network relay device according to claim 1, wherein:
a permission list for identifying, by the use of information included in frames received from an external device, frames that are relay-eligible is stored in the network relay device; and
the relay process section includes an authentication information management section for changing content stipulated in the permission list in response to an external device's state of connection.

8. The network relay device according to claim 7, wherein
if the authentication by the authentication process section has succeeded, the authentication information management section changes the content stipulated in the permission list so as to enable relay of frames received from the external device with which the authentication has succeeded.

9. The network relay device according to claim 7, wherein when the authentication information management section has changed the content of the permission list, the authentication information management section furthermore transmits the content of the changed permission list to a separate network relay device connected to said network relay device.

10. The network relay device according to claim 1, wherein the authentication process section is configured to function both as an authentication client based on IEEE 802.1X and as an authentication server based on IEEE 802.1X.

11. The network relay device according to claim 1, wherein when a separate network relay device has been connected to the network relay device, if the MAC address of the separate network relay device is pre-registered in the network relay device as a MAC address for which connection is to be permitted, the authentication process section treats the separate network relay device as a partner with which mutual authentication has succeeded.

12. A method executed by a network relay device for controlling relay of frames received from external devices, the method comprising:
a step of determining type of authentication that a port of the network relay device to which an external device is connected is configured for;
a step of conducting, if the type of authentication that an external-device-connected port is configured for is a first authentication type, mutual authentication between the network relay device and the external device using an authentication protocol chosen from among a plurality of authentication protocol candidates in accordance with the type of the connected external device;
a step of conducting, if the type of authentication that an external-device-connected port is configured for is a second authentication type, mutual authentication between the network relay device and the external device using a predetermined authentication protocol, regardless of the type of the connected external device; and
a step of relaying frames received from an external device with which mutual authentication has succeeded.

13. A system of network relay devices, comprising:
a first network relay device which is for relaying data frames received from external devices and which includes
a plurality of ports to which external devices connect, and configured pre-correlated with types of authentication to be conducted with respect to connected external devices, the types of authentication including a first authentication type and a second authentication type,
an authentication process section for determining, when an external device is connected to the first network relay device, the type of authentication that the port to which the external device is connected is configured for, and if the determined type of authentication is the first authentication type, conducting mutual authentication between the first network relay device and the external device using an authentication protocol chosen from among a plurality of authentication protocol candidates in accordance with type of connected external device, and
a relay process section for relaying frames received from an external device with which authentication by the authentication process section has succeeded,
a permission list for identifying, by the use of information included in frames received from an external device, frames that are relay-eligible being stored in the first network relay device,
the relay process section including an authentication information management section for changing content stipulated in the permission list in response to an external device's state of connection; and
at least a second network relay device connected to the first network relay device,
wherein when the authentication information management section of the first network relay device has changed the content of the permission list, the authentication information management section furthermore transmits the content of the changed permission list to the second network relay device.

14. A system of network relay devices, comprising:
a first network relay device which is for relaying data frames received from external devices and which includes
a plurality of ports to which external devices connect, and configured pre-correlated with types of authentication to be conducted with respect to connected external devices, the types of authentication including a first authentication type and a second authentication type,
an authentication process section for determining, when an external device is connected to the first network relay device, the type of authentication that the port to which the external device is connected is configured for, and if the determined type of authentication is the first authentication type, conducting mutual authentication between the first network relay device and the external device using an authentication protocol chosen from among a plurality of authentication protocol candidates in accordance with type of connected external device, and
a relay process section for relaying frames received from an external device with which authentication by the authentication process section has succeeded,
the first network relay device having preregistered therein MAC addresses for which connection is to be permitted; and
at least a second network relay device connected to the first network relay device,
wherein if the MAC address of the second network relay device is among those pre-registered in the first network relay device as a connection-permitted MAC address, the authentication process section of the first network relay device treats the second network relay device as a partner with which mutual authentication has succeeded.
